(19) United States
(12) Patent Application Publication
(10) Pub. No.: US 2008/0037072 A1
(43) Pub. Date: Feb. 14, 2008

(54) IMAGE PROCESSING APPARATUS, METHOD, PROGRAM AND STORAGE MEDIUM

(75) Inventor: Takayuki Suzuki, Kawasaki-shi (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: Canon Kabushiki Kaisha, Tokyo (JP)

(21) Appl. No.: 11/830,944

(22) Filed: Jul. 31, 2007

(30) Foreign Application Priority Data
Aug. 10, 2006 (JP) 2006-218976

(51) Int. Cl. H04N 1/393; G06F 15/00; H04N 5/225

(52) U.S. Cl. 358/451; 348/207.2; 358/1.15; 358/1.16; 358/1.2; 348/E05.042

(57) ABSTRACT

A digital camera supplies an image file to a printer and instructs the printer to print the image. If notification, which indicates that printing has failed due to the image file, is received from the printer, the digital camera reduces the data size of the image file and then again supplies the image file to the printer and instructs the printer to print the image.

### BACKGROUND OF THE INVENTION

1. Field of the Invention

The present invention relates to an image processing apparatus, image processing method, program and storage medium. More particularly, the invention relates to a technique for supplying image data to an image forming apparatus, which has been connected to an image processing apparatus so as to be capable of communicating therewith, and instructing the image forming apparatus to print an image.

2. Description of the Related Art

A technique referred to as “direct print” has become widespread in recent years. Direct print involves connecting a digital camera and printer together so as to be capable of communicating, supplying image data from the digital camera to the printer and causing the printer to print an image.

Improvements in the performance of digital cameras have been accompanied by an increasingly greater pixel counts and larger data size of images captured by such digital cameras. Consequently, there are instances where the memory capacity and image processing capability of the printer are insufficient. As a result, the supplied image data cannot be processed by the printer and printing of the image fails.

Accordingly, in a technique proposed heretofore, the printer notifies the digital camera of its own capabilities, the digital camera converts the image data (e.g., reduces pixel counts) in conformity with the capabilities of the printer and then supplies the image data to the printer, whereby printing failure is suppressed (see the specification of Japanese Patent Laid-Open No. 2003-224793).

In accordance with the technique set forth in Japanese Patent Laid-Open No. 2003-224793, it is necessary that the printer has a function for notifying the digital camera of its own capabilities. However, since printers not equipped with this function are already widespread, there are cases where printing failure cannot be suppressed satisfactorily when direct print is performed using a printer already available. A problem which arises with Japanese Patent Laid-Open No. 2003-224793, therefore, is that already widespread printers cannot be exploited effectively.

The present invention has been devised in view of these circumstances and provides a technique whereby it is possible to suppress printing failure even in a case where direct print is carried out using a printer that is not equipped with a function for notifying a digital camera of the printer's own capabilities.

### SUMMARY OF THE INVENTION

According to an aspect of the present invention, there is provided an image processing apparatus comprising an instruction unit which supplies image data to an image forming apparatus, which is connected to the image processing apparatus so as to be capable of communicating therewith, and instructs the image forming apparatus to form an image, a reception unit which receives notification indicating reason for failure that is output, in a case where the image forming apparatus has failed to form the image, from the image forming apparatus, a reduction unit which reduces data size of the image data, and a re-instruction unit which, in a case where the reason for the failure indicated by the notification is ascribed to the image data, supplies the image data to the image forming apparatus after reducing the data size of the image data the reduction unit, and instructs the image forming apparatus to form the image.

According to another aspect of the present invention, there is provided an image processing method comprising the steps of supplying image data to an image forming apparatus, which is connected so as to be capable of communicating, and instructing the image forming apparatus to form an image, receiving notification indicating reason for failure that is output, in a case where the image forming apparatus has failed to form the image, from the image forming apparatus, reducing data size of the image data, and in a case where the reason for the failure indicated by the notification is ascribed to the image data, supplying the image data to the image forming apparatus after reducing the data size of the image data in the step of reducing the size of the image data, and instructing the image forming apparatus to form the image.

Further features of the present invention will become apparent from the following description of exemplary embodiments with reference to the attached drawings.

### BRIEF DESCRIPTION OF THE DRAWINGS

FIG. 1 is a functional block diagram illustrating the configurations of a digital camera and printer used in order to perform direct print;

FIG. 2 is a diagram illustrating the flow of messages sent and received between the digital camera and printer when direct print is performed using a printing system;

FIG. 3 is a flowchart illustrating the flow of processing in which a digital camera causes a printer to print an image by direct print; and

FIG. 4 is a flowchart illustrating the flow of processing in which a user is asked to confirm a reduction in the data size of an image file before the reduction is made.

### DESCRIPTION OF THE EMBODIMENTS

Preferred embodiments of the present invention will now be described with reference to attached drawings. Each embodiment described below will be helpful in understanding a variety of concepts from the generic to the more specific.

It should be noted that the technical scope of the present invention is defined by claims, and is not limited by each embodiment described below. In addition, all combinations of the features described in the embodiments are not always indispensable for the present invention.

### First Embodiment

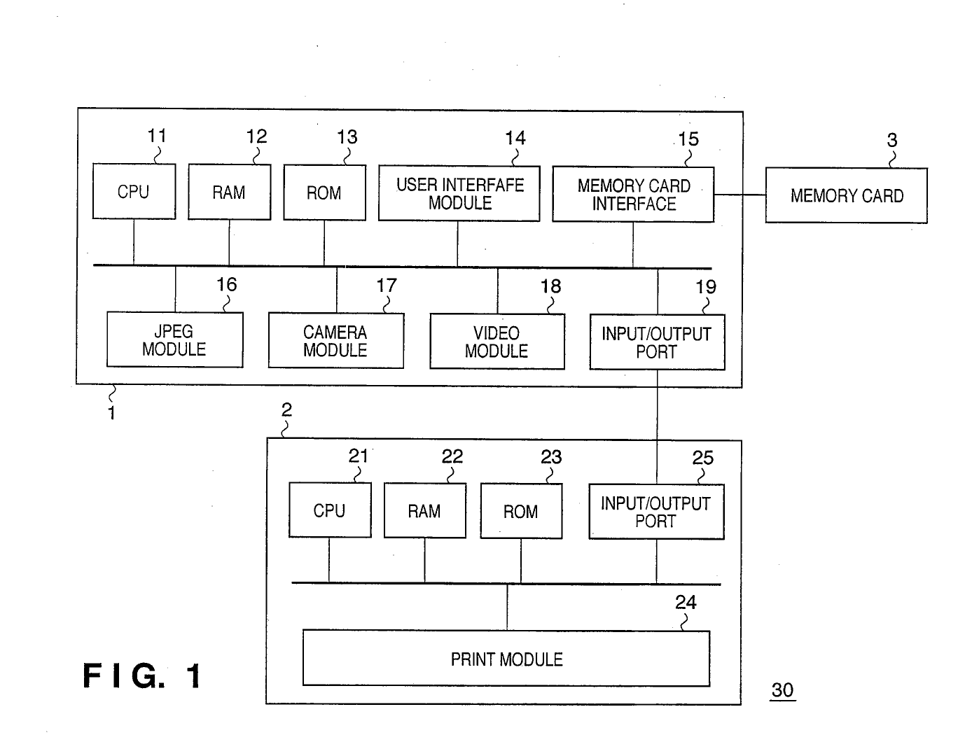

FIG. 1 describes an embodiment in which the image processing apparatus is applied to a digital camera. FIG. 1 is a functional block diagram illustrating the configurations of a digital camera 1 and printer 2 used in order to perform direct print.

The digital camera 1 and printer 2 are connected by wire (e.g., a USB cable, etc.) or wirelessly (e.g., by a wireless communication scheme compliant with IEEE 802.11b), thereby constructing a printing system 30. The digital camera 1 transmits image data to be printed to the printer 2 and instructs the printer to print the image.

A memory card 3 stores image data (primarily image data in the JPEG format) that has been captured by the digital camera 1.

The digital camera 1 includes a CPU 11 for controlling the digital camera 1 and executing various computation processing; a RAM 12 for storing various data during operation of the CPU 11; a ROM 13 in which a program executed by the CPU 11 and various data are stored in advance; a user interface module 14 for acquiring the states of buttons (not shown) operated by the user in order to apply various instructions to the digital camera 1; a memory card interface 15 for connecting the memory card 3; a JPEG module 16 for subjecting image data to JPEG compression processing and JPEG expansion processing; a camera module 17, which includes lenses, a shutter and an image pickup device, for executing image pickup processing; a video module 18 for displaying images and the like on a display unit (not shown) of the digital camera; and an input/output port 19 for connecting the digital camera 1 to a printer 2 or a personal computer so that data may be sent and received.

The printer 2 includes a CPU 21 for controlling the printer 2 and executing various computation processing; a RAM 22 for storing various data during operation of the CPU 21; a ROM 23 in which a program executed by the CPU 21 and various data are stored in advance; a print module 24, which includes a printhead and a motor for paper feed/discharge, for printing image data that has been transmitted from the digital camera; and an input/output port 25 for connecting the printer 2 to the digital camera 1 or a personal computer so that data may be sent and received.

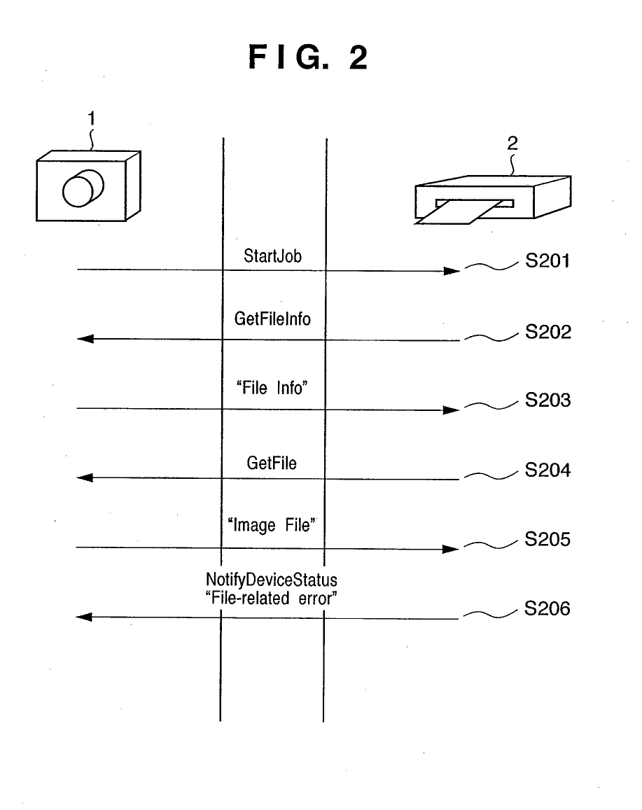

FIG. 2 is a diagram illustrating the flow of messages sent and received between the digital camera 1 and printer 2 when direct print is performed using the printing system 30. FIG. 2 illustrates particularly a case where an error (printing failure) occurs owing to an image file (a file, such as a JPEG file, containing image data).

At step S201, the digital camera 1 transmits a message “StartJob” to the printer 2 and instructs the printer to start printing.

At step S202, the printer 2 transmits a message “GetFileInfo” to the digital camera 1 and requests information (data size, pixel counts, compression scheme, etc.) relating to the image file to be printed.

At step S203, the digital camera 1 sends the printer 2 the information relating to the image file to be printed.

At step S204, the printer 2 transmits a message “GetFile” to the digital camera 1 and requests the image file to be printed.

At step S205, the digital camera 1 transmits the image file to be printed to the printer 2.

The printer 2 analyzes the received image file and, if the image data contained in the image file is printable data, executes printing. If the data contained in the image file is data that is not printable, then the printer 2 transmits an error code to the digital camera 1.

In this embodiment, the image data is not printable owing to the image file (that is, the cause is the pixel counts, the data size of the image, or the like). At step S206, therefore, the printer 2 transmits “File-related Error” to the digital camera 1 with an error code “NotifyDeviceStatus”.

According to this embodiment, the digital camera 1 is capable of continuing print processing even if “File-related Error” is received. This is achieved by the arrangement described below.

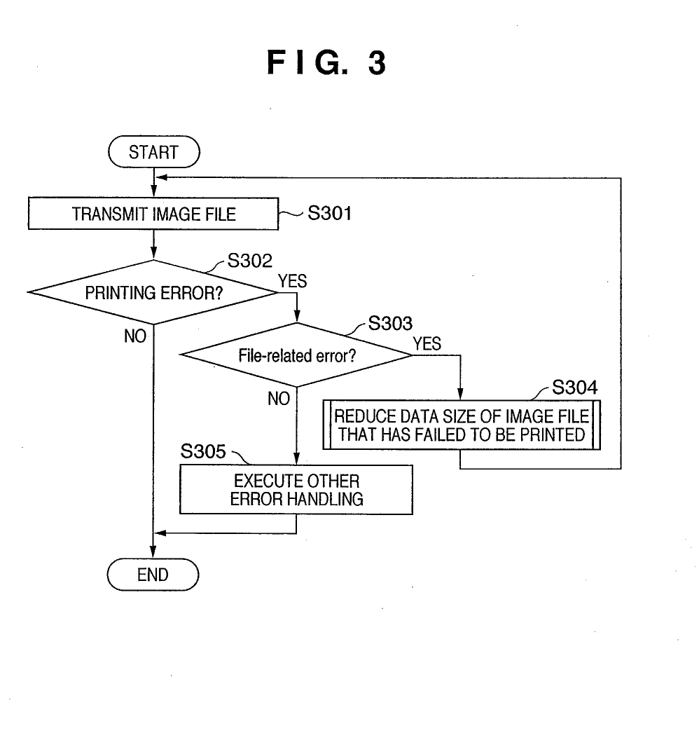

FIG. 3 is a flowchart illustrating the flow of processing in which the digital camera 1 causes the printer 2 to print an image by direct print. The processing of this flowchart starts when the digital camera 1 receives a direct-print instruction from the user via the user interface module 14.

At step S301, the digital camera 1 transmits an image file to be printed to the printer 2. More specifically, the processing indicated at steps S201 to S205 in FIG. 2 is executed.

At step S302, the digital camera 1 determines whether the printer 2 has failed to perform printing (i.e., whether an error code has been received from the printer 2). If the printer 2 has failed to perform printing, control proceeds to step S303; otherwise, processing is terminated.

At step S303, the digital camera 1 determines whether the error that has occurred in the printer 2 is caused by the image file (i.e., whether the error is the “File-related Error”). If the error is caused by the image file, control proceeds to step S304; otherwise, control proceeds to step S305.

At step S304, the digital camera 1 uses the JPEG module 16, etc., to reduce the data size of the image file that has failed to be printed. More specifically, the data size is reduced by raising the JPEG compression ratio or reducing the pixel counts in the image. Control then returns to step S301 and processing similar to that described above is repeated with the image file of reduced data size serving as the image file to be printed. If the printer fails to print even this image file of reduced data size, then the digital camera 1 may abort printing or repeat the processing of step S304 for reducing the data size. If the printer 2 eventually succeeds at printing owing to repetition of the processing for reducing data size, then the end result is that printing failure can be suppressed more satisfactorily.

At step S305, the digital camera 1 executes error handling for dealing with an error other than the “File-related Error” and terminates the processing of this flowchart.

Described next will be a specific example of the processing executed at step S304 to reduce data size. By way of example, the pixel counts contained in the image file is reduced by the digital camera 1 in stepwise fashion. Of course, the digital camera 1 may raise the image compression ratio in stepwise fashion or may reduce the pixel counts and raise the compression ratio in combination. If the pixel counts is reduced, the data size of the image file also will be reduced. That is, the greater the number of times the digital camera 1 subjects the same image file to the processing of step S304, the higher the rate of reduction of the data size.

For example, assume that the pixel counts in the image contained in the image file to be printed is 10,000,000, and assume that the digital camera 1 reduces the pixel counts by 1,000,000 at step S304. In this case, the pixel counts will be reduced by 1,000,000 pixels whenever a printing failure occurs, i.e., to 9,000,000 pixels, 8,000,000 pixels, 7,000,000 pixels, and so on. Eventually, the printer 2 will succeed in printing the image.

The size of the stepwise reduction in the pixel counts may be decided upon taking into consideration the performance of printers sold in the past or by the performance of printers that will be sold in the future. For example, at least one image parameter expressed using the pixel counts and/or compression ratio is stored beforehand in the ROM 13 or in an SRAM (not shown), etc., of the digital camera 1 before the camera is shipped from the factory. The image parameter is “1000, 700, 400, 200, 100, 35”, by way of example. In this example, first the digital camera 1 reduces the pixel counts to 10,000,000 if printing of an image of 16,000,000 pixels fails. If printing fails again, then the camera reduces the pixel counts in stepwise fashion to 7,000,000, then to 4,000,000 and so on.

Further, the digital camera 1 may store an image parameter, which relates to the pixel counts or compression ratio of an image which was used when printing succeeded, in the RAM 12 or in an SRAM (not shown), etc. Then, when direct print is performed the next time using the same printer, control proceeds to step S301 after the data size of the image file is reduced first in accordance with the image parameter which was used when printing succeeded. This reduces the number of trial-and-error operations for reducing the data size of the image file in stepwise fashion, thereby making it possible for the printer to perform printing successfully in a shorter period of time. The image parameter that has been stored in the RAM 12, etc., is retained until the digital camera 1 and printer are disconnected, by way of example.

The embodiment described above is such that if the printer 2 fails to print an image, the digital camera reduces the data size of the image file without the permission of the user. However, there are also cases where the user does not wish to print using an image file whose image quality has been diminished by reducing the data size. Accordingly, the digital camera 1 may be adapted in such a manner that the user is queried as to whether a reduction in data size should be performed or not.

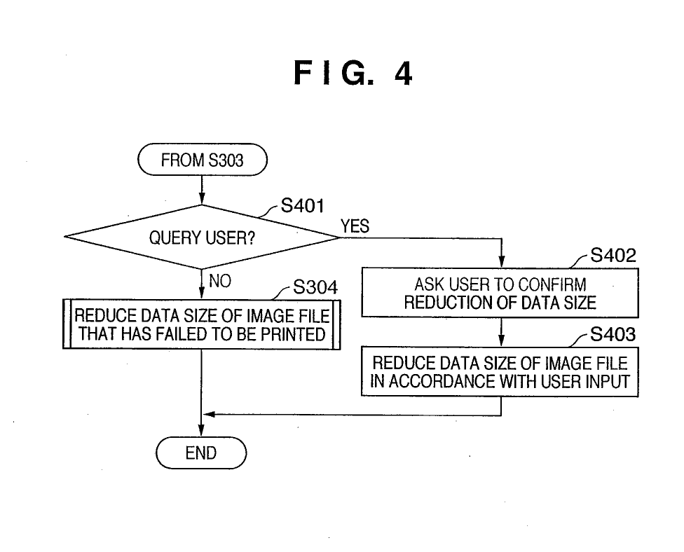

FIG. 4 is a flowchart illustrating the flow of processing in which the user is asked to confirm a reduction in the data size of an image file before the reduction is made. Processing in FIG. 4 identical with that shown in FIG. 3 is defined by assigning the same numerical designations for equivalent steps, and further explanations thereof will be omitted.

At step S401, the digital camera 1 determines whether it is necessary to query the user. If the query is necessary, control proceeds to step S402. If the query is unnecessary, then this case is the same as that shown in FIG. 3 and control proceeds to step S304. Information as to whether or not it is necessary to query the user is stored in, e.g., an SRAM (not shown) of the digital camera 1, and the user can make a change using the user interface module 14.

At step S402, the digital camera 1 prompts the user to instruct whether or not the data size of an image file should be reduced. This may be accomplished by displaying a message on a display unit (not shown). In addition, the user may be allowed to input information regarding the extent of data size reduction (e.g., how large the pixel counts should be made). If the user does not wish for the data size to be reduced, the digital camera 1 aborts printing.

At step S403, the digital camera 1 reduces the data size of the image file by a method identical with that used at step S304 or to the extent of user's input at step S402. Control then returns to step S301.

Thus, in accordance with this embodiment as described above, the digital camera 1 supplies an image file to the printer 2 and instructs the printer 2 to print the image. In a case where the digital camera 1 has received notification from the printer 2 to indicate that printing has failed owing to the image file, the digital camera 1 reduces the data size of the image file and then again supplies the image file to the printer 2 and instructs the printer 2 to print the image.

By virtue of such operation, it is possible to suppress printing failure even in a case where direct print is performed using a printer that does not possess a function for notifying a digital camera of its own capabilities.

Further, even in a case where a printer manufacturer will develop a new printer in the future, it will be unnecessary to equip the printer with a special function for notifying a digital camera of the printer's own capabilities, and it will also be unnecessary to equip the printer with a large-capacity memory in order to suppress printing failure. This is advantageous in that the printer can be supplied at lower cost.

### Other Embodiment

The processing described in the above embodiments may be realized by providing a storage medium, storing program codes of software realizing the above-described functions, to a computer system or apparatus. By reading the program codes stored in the storage medium with a computer (or a CPU or MPU) of the system or apparatus and executing them, the functions of the above-described embodiments can be realized. In this case, the program codes read from the storage medium realize the functions according to the embodiments, and the storage medium storing the program codes constitutes the invention. The storage medium, such as a floppy® disk, a hard disk, an optical disk, a magneto-optical disk and the like can be used for providing the program codes. Also, CD-ROM, CD-R, a magnetic tape, a non-volatile memory card, ROM, and the like can be used.

Furthermore, the functions according to the above embodiments are realized not only by executing the program codes read by the computer. The present invention also includes a case where an OS (operating system) or the like working on the computer performs part or the entire processes in accordance with designations of the program codes and realizes the functions according to the above embodiments.

Furthermore, the program codes read from the storage medium may be written in a function expansion card which is inserted into the computer or in a memory provided in a function expansion unit which is connected to the computer. Thereafter, a CPU or the like contained in the function expansion card or unit may perform part or the entire processes in accordance with designations of the program codes and may realize the functions of the above embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-218976, filed on Aug. 10, 2006, which is hereby incorporated by reference herein in its entirety.

What is claimed is:

1. An image processing apparatus comprising:
an instruction unit which supplies image data to an image forming apparatus, which is connected to the image processing apparatus so as to be capable of communicating therewith, and instructs the image forming apparatus to form an image;
a reception unit which receives notification indicating reason for failure that is output, in a case where the image forming apparatus has failed to form the image, from the image forming apparatus;
a reduction unit which reduces data size of the image data; and
a re-instruction unit which, in a case where the reason for the failure indicated by the notification is ascribed to the image data, supplies the image data to the image forming apparatus after reducing the data size of the image data said reduction unit, and instructs the image forming apparatus to form the image.

2. The apparatus according to claim 1, wherein in a case where the notification indicates that the reason for the failure is ascribed to the image data, said re-instruction unit repeats supplying the image data to the image forming apparatus after further reducing the data size of the image data by said reduction unit and instructing the formation of the image, until the image forming apparatus succeeds in forming the image contained in the image data.

3. The apparatus according to claim 1, wherein said reduction unit reduces the data size of the image data by reducing pixel counts.

4. The apparatus according to claim 1, wherein said reduction unit reduces the data size of the image data by raising the compression ratio of the image data.

5. The apparatus according to claim 2, wherein when reducing the data size of the image data by said reduction unit, said re-reduction unit controls said reduction unit in such a manner that the larger the number of times said reduction unit is applied to the same image data, the more the reduction ratio of the data size is raised.

6. The apparatus according to claim 1, wherein in a case where formation of an image relating to image data to which the data-size reduction processing by said reduction unit has been applied succeeds, said re-instruction unit stores the method of the data-size reduction processing that was applied last by said reduction unit in a storage unit; and
in a case where formation of the image is subsequently instructed by said instruction unit, said instruction unit reduces the data size of the image data by said reduction unit using the method of the data-size reduction processing stored in said storage unit prior to the instruction.

7. The apparatus according to claim 1, wherein said reduction unit has an acceptance unit which accepts from a user an instruction as to whether or not the data size of the image data should be reduced, said reduction unit reducing the data size of the image data only in a case where an instruction indicating that the data size of the image data should be reduced has been accepted from the user.

8. An image processing method comprising the steps of:
supplying image data to an image forming apparatus, which is connected so as to be capable of communicating, and instructing the image forming apparatus to form an image;
receiving notification indicating reason for failure that is output, in a case where the image forming apparatus has failed to form the image, from the image forming apparatus;
reducing data size of the image data; and
in a case where the reason for the failure indicated by the notification is ascribed to the image data, supplying the image data to the image forming apparatus after reducing the data size of the image data in said step of reducing the size of the image data, and instructing the image forming apparatus to form the image.

9. A program, which is stored on a computer-readable storage medium, for causing a computer to execute the image processing method according to claim 8.

10. A computer-readable storage medium on which the program according to claim 9 is stored.
